(19) United States
(12) Patent Application Publication
(10) Pub. No.: US 2017/0046809 A1
(43) Pub. Date: Feb. 16, 2017

(54) My Personal Identification Mobile Wallet

(71) Applicant: Evelyn Laureano-Osorio, Carolina, PR (US)

(72) Inventor: Evelyn Laureano-Osorio, Carolina, PR (US)

(21) Appl. No.: 14/999,258

(22) Filed: Apr. 6, 2015

(51) Int. Cl. G06Q 50/26; G06F 21/31

(52) U.S. Cl. CPC G06Q 50/265; G06F 21/31

(57) ABSTRACT

In May 23, 2012, I register as inventor a copyright (Txu 1-803-905) of this innovation never mentioned before or realized as a need for people, government, national security and private sector to accelerate individual identity for different transaction when an id like the driver license is requested by the parts mentioned above.

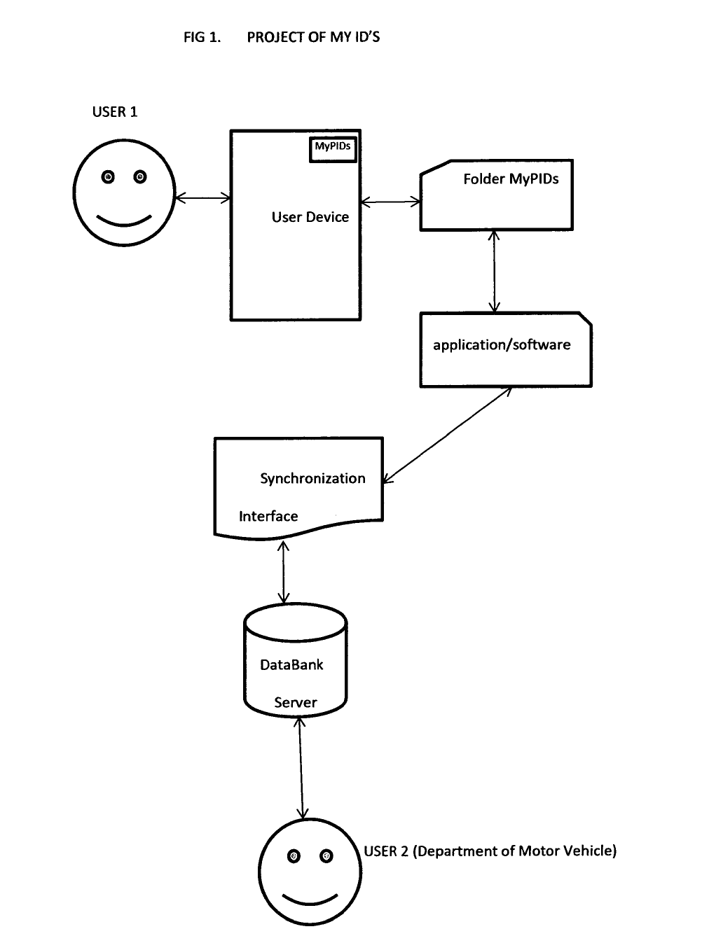

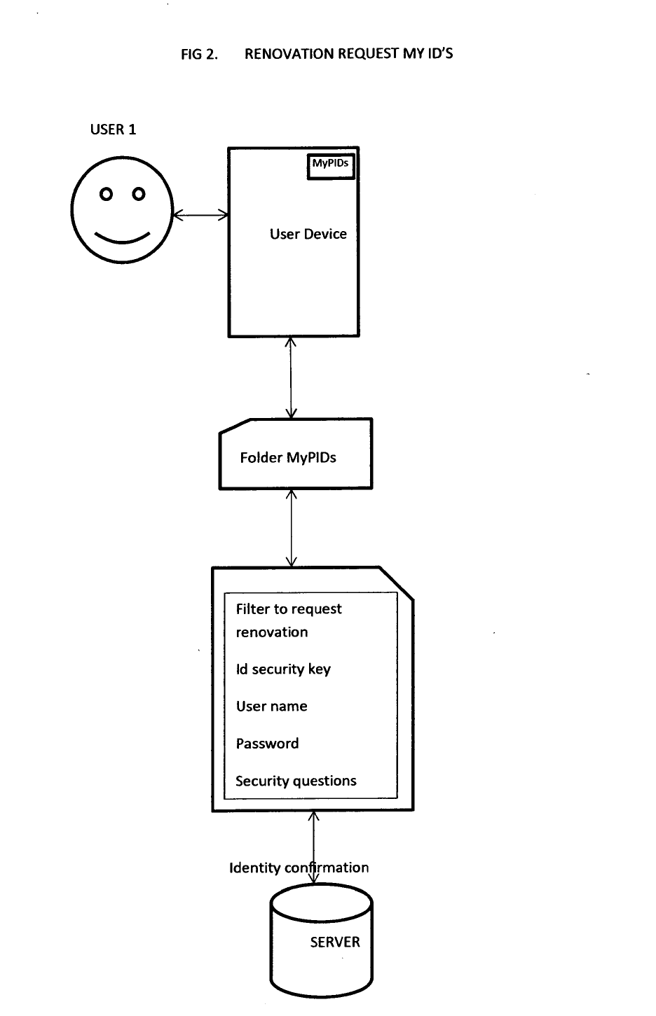

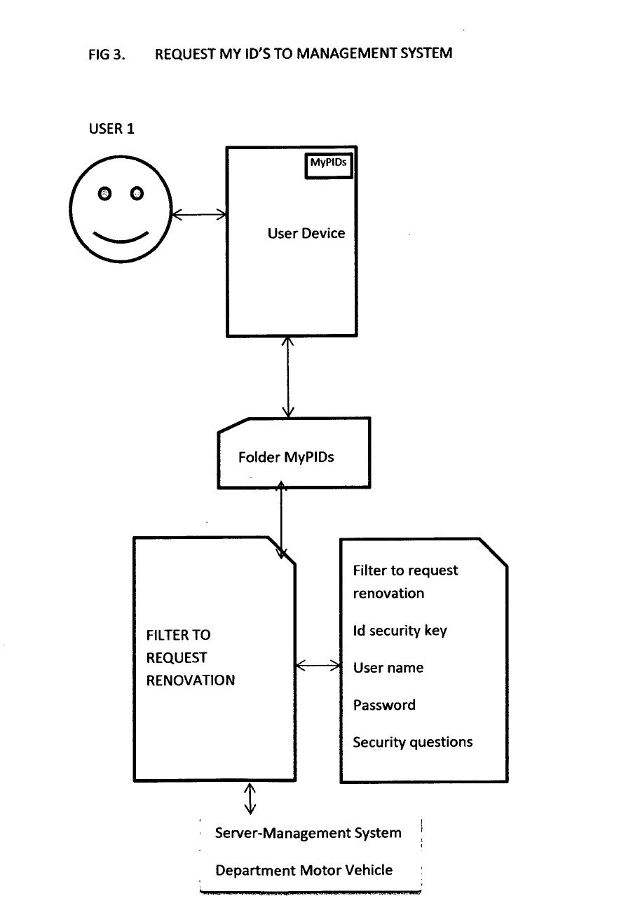

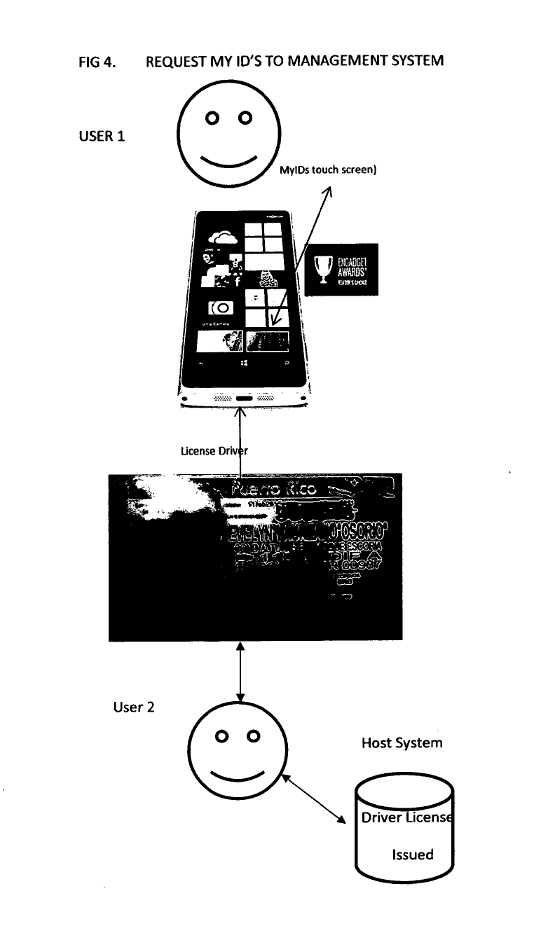

This process and procedures system is the results of a night revelation. I have in my personal notes step by step of what I saw in the dream or a visual idea. I was praying and the image of and icon like an id with my photo appear in my dream. This document specifically states the user point of view and needs to create the innovation of a unique process and procedures for personal secure “software” that comprise of a folder named my personal identifications mobile wallet, MyPID's. My original idea is first for mobile and smart phone to automatically by a design of an application or software give user the opportunity to transfer after validation by official entities verify and approve the identity like the same process for plastic id cards, such as driver license, health insurance and others, the difference in this instance is that the validation will be virtual authentic originals locate at the mobile phone. These processes will be available for mobile computing device, smart phone, e.g., intelligent phone, tablets and personal portable media player, e.g., but with the capacity to developers to enhance in a future after this phase for desktop and other hardware communication products.

### INTRODUCTION

This document states the innovation of a unique process and procedures to create a personal secure folder named my personal identifications mobile wallet-MyPIDs-)—to automatically by a design of a unique application give users of computing devices the opportunity to transform plastic id cards, such as driver license, health insurance to a digital authentic originals. These processes will be available for, blackberry mobile computing device, e.g., mobile telephone, smart telephone, e.g., intelligent phone, personal digital assistant or pda, portable media player, e.g., ipod), etc. but with the capacity to developers to enhance for desktop and other hardware communication products. In May 23 2012 I register the copyright of this innovation never mentioned before or realized as a need for people, government and national security and private sector to accelerate commercial transaction. This process and procedures system is the results of a revelation and I have in my personal notes step by step of what I saw in the dream or a visual idea.

As mobile computing devices have become more central to users' everyday lives, it is not uncommon for a user to carry his/her mobile computing device nearly everywhere him or her going and travels. For example, users often carry their mobile computing devices with them at home, at work, church and at social events.

Also it is common for users to carry constantly many identification cards because it's impossible to remember all the intelligent numbers to adjust everyday life profile to commercial and vital transactions demands of the social and economic environment, failing to properly have an option in light of the device's current context can be problematic for users to have access on time and properly to all-MyPIDs accurately, secure and automatically. It is quit fundamental to modern technology to provide users the opportunity to create their owns—MyPIDs—folder in device with a digital authentic security certificate to satisfy all identity demands of official governments and private sectors. Federal and State government should do proper adjustment in law and regulation to facilitate users the opportunity to have virtual electronic ids to perform and share transactions among government and private context. This includes security government institutions and private sector. In the case of the police departments in the states a scanner will be prepare to read the user digital intelligent phone and have access directly to the saver where data in storage.

A system for access ids profiles on mobile computing device is needed and comprise: a mobile computing device; a context determination unit of the mobile computing device that is configured to access a determined contexts associated with the user ids, the context is external to the mobile computing device.

A location description unit for mobile computing device should be configured to—MyPIDs—. The ids description includes a user custom maid application for textual description and picture that will be configured to give user the security to select a user name, a password, save personal data and to update data. This system will be work like the one used by commercial banks accounts with the addition of specific personal data and photo in the case of driving license. Various advantages can be realized with this invention such as providing users and provider's institutions with a greater rapidly convenience when ids are necessary to be presented and are storage permanently with option to update data and to eventually substitute the plastic ids cards in wallet with—MyPIDs—

### SUMMARY OF THE PROCESS INNOVATION

A transaction management system may includes: a server that hosts a transaction; a network; a client connected in a communicating relationship with the server over the network, and the client participating in the transaction hosted by the server; and a filter operating between the server and the client to capture data associated with the transaction.

System and method to transform information from a host system to a mobile data communication device: A exemplary system for implementing the invention includes a general purpose computing device in the form of a smart phone or blackberry and others as mentioned above.

Components of external computer may include, but are not limited to, a processing unit, a system memory, and a system bus that couples various system components including 2 the system memory to the processing unit.

1. the device—with capacity to create a secure separate folder for—MyPIDs—with executable instructions that, when executed to perform a method of separating data and stored in a namespace, comprised the functions of: creating a personal users folder configured to store ids profiles digital data and security certificates for a plurality users; creating a folder with the design menu for this purpose to storing personal information to be shared with other users. —MyPIDs folder being a subfolder under users folder category saved by the user.

2—The folder-readable storage unit wherein the documents folder comprises a default storage location for storing in a subfolder MyPIDs for diverse documents created by the user.

3. The applications—have the capacity to share—MyPIDs— with other user. The shared—MyPIDs folder includes synchronized copies of data shared with the user by the other users.

4. The interface synchronization—The computer may operate in a networked environment using logical connections to one or more remote computers. The remote computer may be a personal computer, a server, a router, a network pc, a peer device or other common network node, and typically includes many or all of the elements described above relative to the computer. The logical connections depicted in include a local area network (lan) and a wide area network (wan), but may also include other networks. Such networking environments are commonplace in offices, enterprise-wide computer networks, intranets and the Internet.

5—In another aspect the invention may provide a user with the capability of sharing information with other users from within their own—MyPIDs—virtual folder. Moreover, a user may have the capability to define and individually control other users rights to data contained to be shared. The invention will be provided with read only access to prevent remote users affect others files placed in—MyPIDs—folder.

6—Each authenticated user of a computing system may have their own user profile on the system in which to store their own data. Each user profile may be identified through use of a combination of alphanumeric characters from a user's first and last name. Those skilled in the art will realize that numerous combinations of characters may be utilized to identify a user's profile.

7—A software application operating at the mobile device and the host system synchronizes the folder of the mobile device with a folder at the host system and the mobile device then automatically replicated the same data items stored at the host system. A replication of object format data items can be performed of a particular complete objects such as: driving license with photo, health insurance, social security and birth certificate among others.

8—The folder structure includes a folder id, folder type, folder name, and parent folder id. The folder id is a unique tag for each folder. The folder id is generated when the mobile device is synchronized to the host system. The type of folder specifies attributes of the folder that differentiate it from other folders. The folder name is the name of the folder that will be displayed on the device or the host system.

9—An operating system may provide an interface between the mobile computing device's hardware (e.g., the input/output mechanisms and a processor executing instructions retrieved from computer-readable medium) and software.

Example operating systems include the android mobile mobile computing device platform; apple phone/mac xp operating systems; Microsoft window window 7/window mobile operating systems; symbiam operating system; rim blackberry operating system; palm web operating system; a variety of unix-flavored operating systems; or a proprietary operating system for computerized devices. The operating system 3 may provide a platform for the execution of application programs that facilitate interaction between the computing device and a user.

10—The mobile computing device may present a graphical user interface with the touch screen. A graphical user interface is a collection of one or more graphical interface elements and may be static (e.g., the display appears to remain the same over a period of time), or may be dynamic (e.g., the graphical user interface includes graphical interface elements that animate without user input) depends of the creative capacity of the developers.

11—A graphical interface element may be text, lines, shapes, images, or combinations thereof. For example, a graphical interface element may be an icon that is displayed on the device or desktop and the icon's associated text. In some examples, a graphical interface element is selectable with user-input.

For example, a user may select a graphical interface element by pressing a region of the touch screen that corresponds to a display of the graphical interface element. In some examples, the user may manipulate a trackball to highlight a single graphical interface element as having focus.

User-selection of a graphical interface element may invoke a pre-defined action by the mobile computing device. In some examples, selectable graphical interface elements further or alternatively correspond to a button on the keyboard.
Evelyn Laureano, ph.d, copyright in May 23 2012
apr. 2, 2015
200 Blvd. Media Luna, Alturas de Parque Escorial, apt 1104
Carolina, Commonwealth of Puerto Rico, 00987
Phone 787-202-1260
laur_lauri®yahoo.com

1. To provide a software with an a “Unique Folder” for users in the specific system context to storage MyPID's with their identity profiles and confirmation requested and received on mobile computing devices.

2. The claim 1, need and comprise: a mobile computing device; a context determination unit of the mobile computing device that is configured to access a determined contexts outside associated with the user ids, the context is external to the mobile computing device (Department of Motor Vehicle and Driver License) server. The outside context will have access to the request and answer validation of identity.

3. The claim 2 specify the creation and configured in Window or other platform a unit for mobile computing device to storage-MyPIDs-configuration will includes a user custom maid and friendly application alphanumeric (with demographic, biometric and health data authorized by authorities related with filed prior record with physical documents), description and picture (photo) that will be configured to give user the security to select a name, a password, security questions and save personal data and to update data.

4. In claim 3 the procedures will work like the one used by commercial banks accounts with user name, password one-time password (OTP), security question to open and close the folder and manage transactions with specific personal data and photo in the case of driving license.

5. claim 4 State clearly the need of passwords and security questions of certificates of security that only the user can have access to validate demographic data and photo with the outside context and for his/her own. He or she will use the system in a first phase only to renovation of identity driver license cards. Smart card technology in the mobile device can also be used to protect consumer privacy in a convenient, cost-effective, and easy-to-use way. The user may only change as his own decision sensitive security password and security questions as bank accounts,

6. State that claim 5 is an “Identity Unit at Users Devices” to storage location of information among the functionality of the Management System as Morpho Trust patent solicitation Ser. No. 14/470688 or 20150063655.

7. An outside transaction management system is required as an fundamental procedures to validate identity. This includes: a server that hosts a transaction; a network; a user connected in a communicating relationship with the server over the network, and the user participating in the transaction hosted by the server; and a filter operating between the server and the client to capture data associated with the transaction. The identification process is out of this software system and correspond to other system to process data requested by user of the public sector.

8. The Certificate Authority interacts with the identity transaction system in a accordance of a period of time to give permissions granted by manual human inspection and mediation. Using a score based matrix of quality and quantity of validate identification documents.

9. A system and method to transform individual identity information from a host system to the user mobile data folder need a communication system with the user and the agency. Components of external computer may include, but are not limited to, a processing unit, a system memory, and a system bus that couples various system components including the system memory to the processing unit.

10. This implementations provide a the invention of this software for portable computing devices where the user initiates and authorizes the privileges associated with his/her credentials in direct communication with qualified certificate authority such as, a government agency or official organization and managed by an identity data transaction system.
